(19) United States
(12) Patent Application Publication
(10) Pub. No.: US 2015/0184427 A1
(43) Pub. Date: Jul. 2, 2015

(54) Free Wheel Lock For Bicycle

(71) Applicant: Lloyd Blackman, Houston, TX (US)

(72) Inventor: Lloyd Blackman, Houston, TX (US)

(21) Appl. No.: 14/141,114

(22) Filed: Dec. 26, 2013

(51) Int. Cl. E05B 71/00

(52) U.S. Cl. CPC E05B 71/00

(57) ABSTRACT

A method and apparatus for securing the free wheel of a bicycle to prevent rotation. Such rotation may be distracting and hazardous when a bicycle is transported on a vehicle rack. The apparatus comprises an elongated body with two curved ends, the body is separable to extend the distance between the curved ends such that they can be positioned between the wheel and/or the frame components of the bicycle to secure the wheel against rotation and turning.

### NOTICE OF INTENT TO RESERVE COPYRIGHT OR MAST WORK RIGHTS

Not Applicable

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

When transporting a bicycle on a vehicle bike carrier, the motion of the vehicle causes issues with bicycles on an external carrier. The free wheel (i.e., that without the friction of the chain and gear system) may rotate as the vehicle accelerates and decelerates. The turning can cause damage to the bike, or the transport vehicle. The movement can also be a distraction for the driver. Drivers who ‘tune out’ or ignore this movement as seen in mirrors or as reflections of vehicle surfaces can cause a driver to unintentionally miss other roadway hazards they mistakenly believe to be the bike's movement.

### BRIEF DESCRIPTION OF THE DRAWINGS

FIG. 1 illustrates a perspective view of a Free Wheel Lock in accordance with an exemplary embodiment of the invention.

FIG. 2A illustrates a frontal view of a Free Wheel Lock in accordance with an exemplary embodiment of the invention.

FIG. 2B illustrates a side view of a Free Wheel Lock.

FIG. 2C illustrates a cross sectional view of a Free Wheel Lock in accordance with an exemplary embodiment of the invention.

FIG. 3A illustrates a side view of a Free Wheel Lock in an opened position.

FIG. 3B shows a cross sectional view of a Free Wheel Lock in an opened position in accordance with an exemplary embodiment of the invention.

FIG. 4 shows an alternative assembly of a Free Wheel Lock in a rotated position in accordance with an exemplary embodiment of the invention.

FIG. 5A shows a detailed view of the preferred latching mechanism of a Free Wheel Lock in a locked position.

FIG. 5B shows a detailed view of the preferred latching mechanism of a Free Wheel Lock in an unlocked position.

FIG. 6A shows a close-up front view of an alternative latching mechanism of a Free Wheel Lock in an opened position in accordance with an exemplary embodiment of the invention.

FIG. 6B shows a close-up side view of an alternative latching mechanism of a Free Wheel Lock in an opened position in accordance with an exemplary embodiment of the invention.

FIG. 7 shows a bicycle with two exemplary placements for a Free Wheel Lock in accordance with an exemplary embodiment of the invention.

### DETAILED DESCRIPTION OF THE PREFERRED EMBODIMENTS

Described herein is a free wheel lock for a bicycle for use during transportation of the bicycle on a carrier. The primary purpose of the free wheel lock is to prevent the free wheel from rotating during transportation. Additionally, some versions of the device may be equipped with a keyed locking mechanism which provides anti-theft security is well.

The device is assembled in two similar halves which mate through a locking rod permanently affixed to one half, and removable affixed to the other half. The distal ends form curved hooks which grasp the wheel rim or the tubular of the bike frame to secure the wheel from rotating.

In the preferred embodiment, the locking, rod has teeth on a plurality of sides to allow the two halves to be rotated around the rod's central axis in relation to each other so that the hooks may orient in independent directions to each other, allowing multiple configurations to satisfy different application needs of the user.

The preferred embodiment is constructed of a metal frame, to provide strength, encased in a molded plastic to prevent scratching or corrosion of the bicycle. In alternative embodiments, the frame may be made of a durable plastic which is encased in a rubberized plastic or left in the non-encased state. In alternative embodiments the device may be constructed with fiber glass, carbon fiber, resin, or other materials for durability and wear resistance.

In the preferred embodiment, the inner surface of the hooks are further lined with padding or cushioning. This prevents bending of frame structures, or crushing of cables. The hooks are sized and curved to fit standard tubular structures. Alternative embodiment may comprise different sized hooks for different bicycle sizes. Alternative embodiments may comprise different shaped hooks for mating with different bicycle parts.

In the preferred embodiment, the two halves are substantially similar in size and shape. In alternative embodiment, the division between the two hooks may be oriented more toward one hook rather than being positioned near the middle of the body. In such a configuration, the locking d would be permanently affixed to the shorter side, and extend into a cavity on the longer side. The longer side comprises a latching mechanism for securing the rod at a plurality of locations upon its length.

The two halves of the preferred embodiment are joined by a locking rod which is permanently affixed to one side, and nest in a locking cavity in the other side. The locking cavity has a latching mechanism which engages the locking rod as it is inserted into the locking cavity, while not preventing further insertion into the cavity. However, the latching mechanism prevents the locking rod from sliding back out of the cavity unless it is disengaged. Disengaging the latching mechanism may require a key or combination which disengages a lock, or it may he a lever which requires simple force to overcome a biasing spring urging the lever to a locked position.

In another embodiment, the latching mechanism may comprise a friction hold Where a clasp secures the locking rod between a plurality of body parts on the other half to secure the two halves from separating. In an exemplary embodiment, the clasping may be a screw with a nut providing compression against the screw head.

In another embodiment, the two halves comprise at least one, but preferable a plurality of guide bars which nest into mating cavities on the opposing half, having a spring or other elastic member extended between the two halves. The two halves are pulled apart by a force overcoming the joining force of the spring, and then positioned as desired. Releasing the two halves allows the elastic member to urge the two halves back together with the guide bars, ensuring alignment when mated.

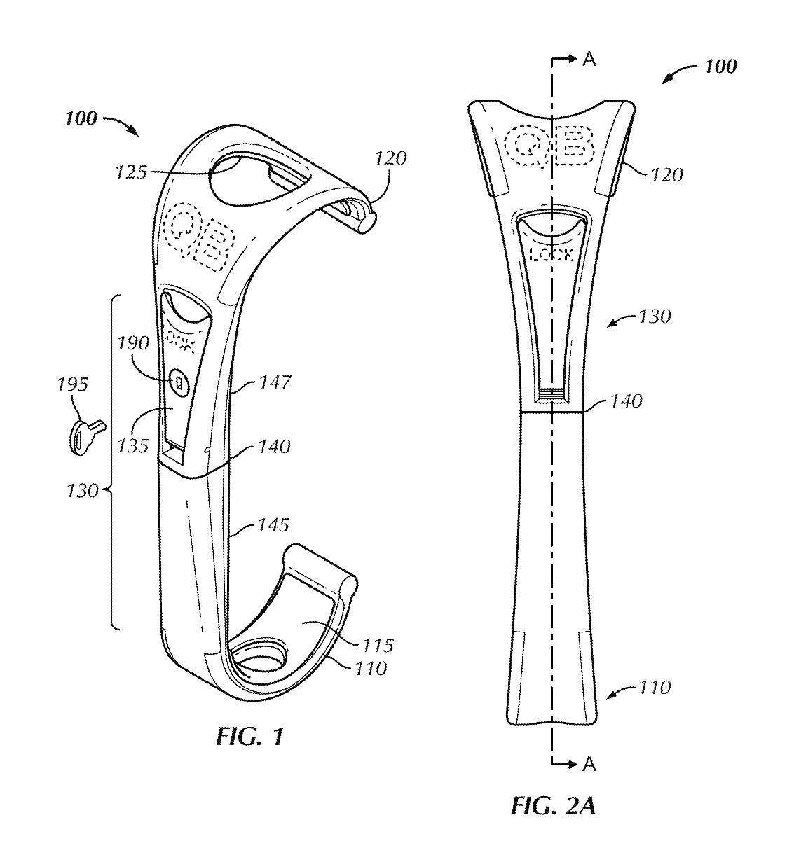

FIG. 1 illustrates a perspective view of a Free Wheel Lock in accordance with an exemplary embodiment of the invention. The wheel lock (100) comprises two hooks, (120 and 110) each lined with foam padding (115 and 125). The two hooks are joined to distal ends of a body (130) which divides at an expansion joint (140) creating two halves (145 & 147). For purposes of this discussion, the upper half (147) is illustrated with a hook (120) which flares more than the hook (110) of the lower half (145); however, the two hooks could be substantially similar.

In the illustration, the upper half (147) comprises the locking cavity (not visible) Which accepts the locking bar (not visible) and includes the release lever (135), which optionally contains a lock (190) secured with a key (195).

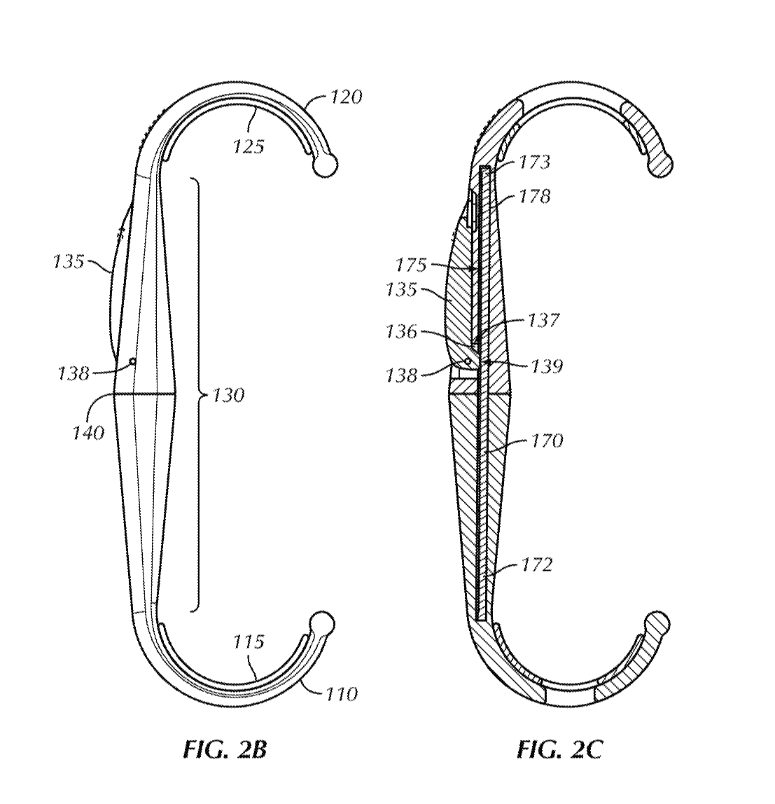

FIG. 2A illustrates a frontal view of a Free Wheel Lock in accordance with an exemplary embodiment of the invention. The wheel lock (100) is illustrated in a closed position where the upper half (147) with the flared hook (120) and the lower half (145) with the non-flared hook (110) are mated at the expansion joint (140) of the body (130).

FIG. 2B illustrates a side view of a Free Wheel Lock. In the side view, the foam pad (125) is shown to line the upper hook (120) and another foam pad (115) lines the lower hook (110). Just above the expansion joint (140) of the body (130) the pivot point (138) of the latch (135) is illustrated.

FIG. 2C illustrates a cross sectional view of a Free Wheel Lock in accordance with an exemplary embodiment of the invention. In the cross sectional view, the locking bar (170) is shown to have a secured end (172) which is attached/secured permanently into the lower half (145). The projecting end (173) extends into the sleeve (178) of the upper half (147) and the teeth (175) of the locking bar (170) engage the teeth (139) of the cam (137) on the end of the release lever (135). Pulling the release lever (135) rotates it around the pivot point (138) causing, the teeth (139) to rotate up into the void (136) and disengage from the teeth (175) of the locking bar (170). This then allows the locking bar (170) to be removed from the sleeve (178) of the upper half, (145) extending the distance between the two hooks (110 and 120).

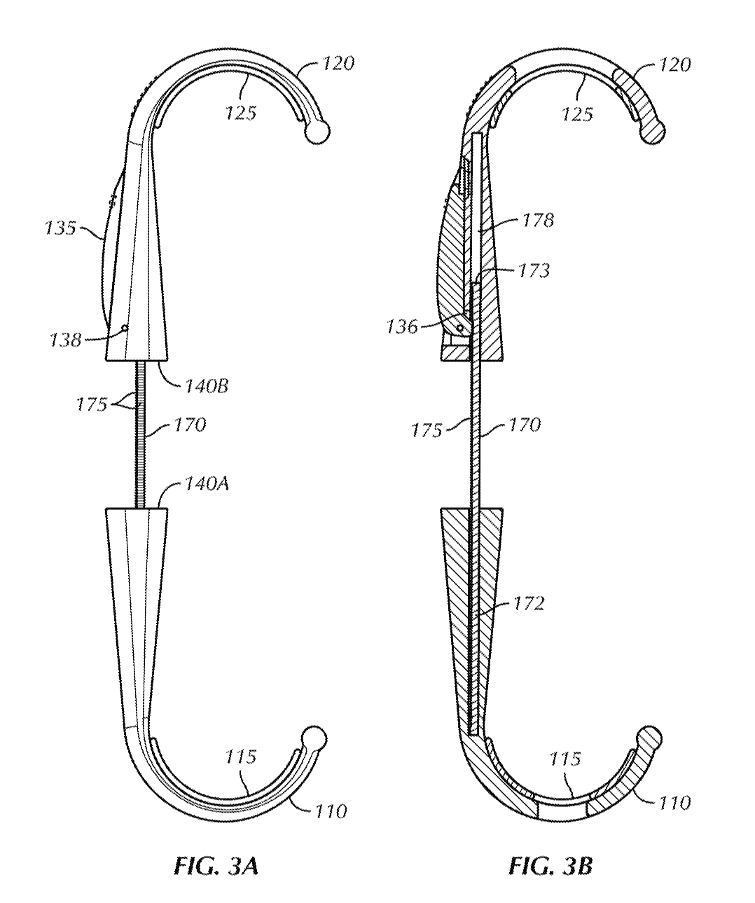

FIG. 3A illustrates a side view of a Free Wheel Lock in an opened position. In the side view, the foam pad (125) is shown to line the upper hook (120) and another foam pad (115) lines the lower hook (110). The expansion joint (140A and 140B) is opened with the upper half (147) and the lower half (145) joined by the locking bar (170). The pivot point (138) of the latch (135) is illustrated on the upper half (147). The teeth (175), visible on the front and side of the locking bar (170), allow the lower half (145) to be rotated around the central axis of the locking bar (170) with respect to the upper half (147).

FIG. 3B shows a cross sectional view of a Free Wheel Lock in an opened position in accordance with an exemplary embodiment of the invention. In the cross sectional view, the locking bar (170) is shown to have a secured end (172) which is attached/secured permanently into the lower half (145). The projecting end (173) extends into the sleeve (178) of the upper half (147) and the teeth (175) of the locking bar (170) engage the teeth (139) of the cam (137) on the end of the release lever (135). Pulling the release lever (135) rotates it around the pivot point, (138) causing the teeth (139) to rotate up into the void (136) and disengage from the teeth (175) of the locking bar (170). This then allows the locking bar (170) to he removed from the sleeve (178) of the upper half (147) extending the distance between the two hooks (110 and 120). The teeth (175), located on the other sides of the locking bar (170), allow the lower half (145) to be rotated around the central axis of the locking bar (170) with respect to the upper half (147) while still presenting teeth (175) to engage the teeth (139) of the lever (135).

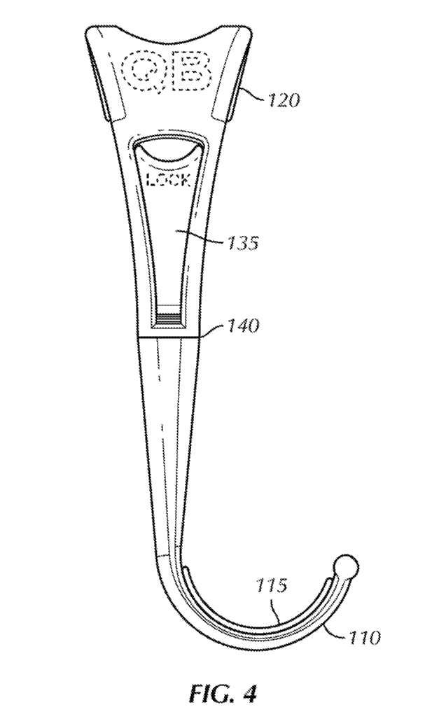

FIG. 4 shows an alternative assembly of a Free Wheel Lock in a rotated position in accordance with an exemplary embodiment of the invention. The lower half (145) is illustrated in a rotated position around the expansion joint (140) with respect to the upper half (147), as illustrated by the forward presentation of the latch (135) and the rear presentation of the upper hook, (120) while the lower hook (110) with its foam padding (115) is presented to the side.

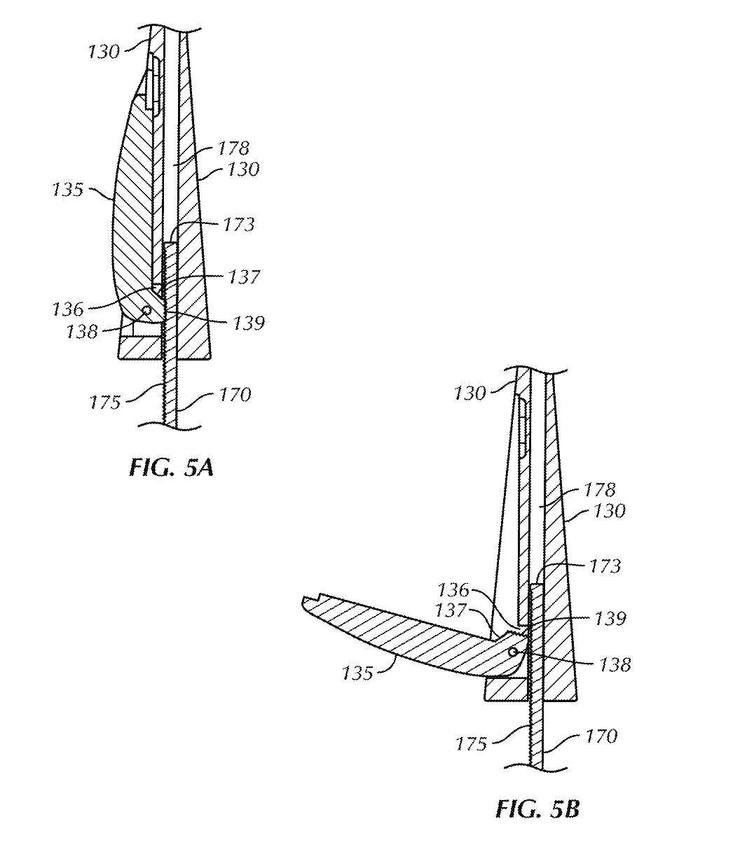

FIG. 5A shows a detailed view of the preferred latching mechanism of a Free Wheel Lock in a locked position. The close up view details the pivot point (138) of the latch (135) in relation to the body (130). The cam (137) extends the teeth (139) of the latch (135) to engage the teeth (175) of the projecting end (173) of the locking bar (170) as it is inserted into the sleeve (178) of the body (130). A spring mechanism (not illustrated) urges the handle of the lever (135) against the body (130).

FIG. 5B shows a detailed view of the preferred latching mechanism of a Free Wheel Lock in an unlocked position. An opening force (not illustrated) rotates the lever (135) away from the body (130) against the urging of a spring mechanism (not illustrated). This allows the lever (135) to rotate around the pivot point, (138) moving, the teeth (139) on the cam (137) into the void (136) of the body (130) and disengaging the teeth (175) of the locking bar (170), allowing it to be removed from the (178).

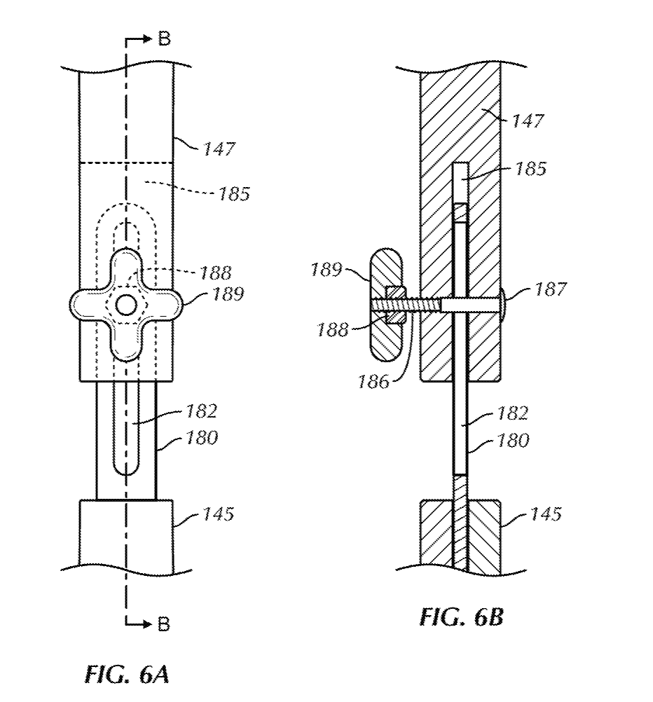

FIG. 6A shows a close-up front view of an alternative latching mechanism of a Free Wheel Lock in an opened position in accordance with an exemplary embodiment of the invention. FIG. 6B shows a close-up side view of an alternative latching mechanism of a Free Wheel Lock in an opened position in accordance with an exemplary embodiment of the invention. In this embodiment, the upper and lower halves (145 and 147) remain joined by a catch end, (184) enclosing the end of a slotted opening (182) of the locking lever (180). The body (130) is notched to allow the locking lever (180) to be sandwiched in between the two notch halves. A screw (186) passes through the notched body perpendicular to the notch. The screw (186) also passes through the slotted opening (182) of the locking lever (180). A nut (188) with a handle (189) affixed thereto can he secured to the screw, (186) placing pressure through the body (130) and the locking lever (180) against the screw head (187) to produce a fiction force holding the two halves (145 and 147) in relation to one another.

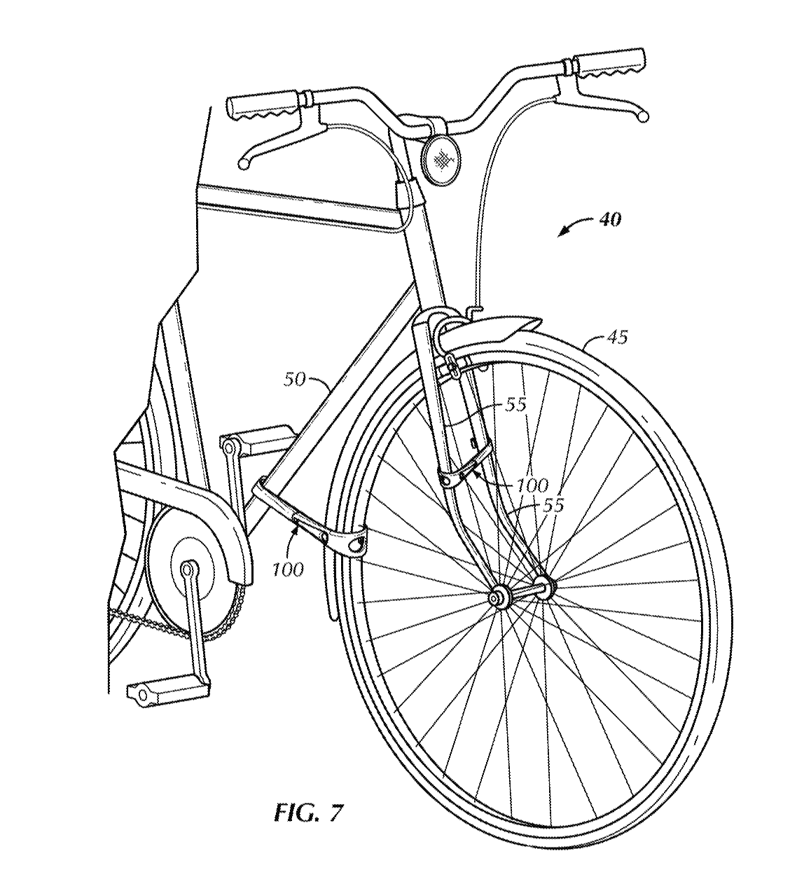

FIG. 7 shows a bicycle with two exemplary placements for a Free Wheel Lock in accordance with an exemplary embodiment of the invention. The bicycle's (40) front forks (55) have a wheel lock (100) passing across and securing to them. This stops the wheel (45) from rotating. In an alternative application, a wheel lock (100) secures the tire (45) by placing pressure against the inside of the tire (45) frame and the down tube (50) of the bicycle (40) frame. This alternative application prevents the wheel for rotating, and additionally prevents the wheel from turning.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally. some elements illustrated in the singularity may actually be implemented in a plurality. Further, some elements illustrated in the plurality could actually vary in count. Further, some elements illustrated in one Ruin could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is filly appreciated. It is intended that the following chums be interpreted to embrace all such variations and modifications.

What is claimed is:

1. An apparatus for securing a bicycle wheel comprising:
a first curved end;
a second curved end; and
a body for joining the two curved ends.

2. An apparatus as described in claim 1 wherein the first curved end attaches to the frame of the bicycle and the second curved end attaches to the frame of the bicycle, the body being. positioned to pass through the spokes of the wheel.

3. An apparatus as described in claim 1 wherein the first curved end attaches to the wheel of the bicycle and the second curved end attached to the frame of the bicycle.

4. An apparatus as described in claim 1 wherein the body is separable into:
a first portion haying at one end, the first curved end;
a second portion having at one end, the second curved end;
the distal end of each portion being removably joinable near the center of the body.

5. An apparatus as described in claim 4 wherein the two portions of the body are secured by:
a locking bar;
the bar being permanently secured to the second portion and extending therefrom;
the bar being removably insertable into a cavity in the first portion; and
the first portion further comprising a latching mechanism.

6. An apparatus as described in claim 5 wherein the locking bar has teeth along, at least one elongated side of the locking bar; and
the latching mechanism further comprises:
a lever biased toward a locked position;
a cam at the pivotable end of the lever;
the cam having teeth which mate with the teeth of one side of the locking bar allowing the bar to insert into the cavity but not remove from the cavity while the teeth are engaged,
the cam being pivotable to disengage the teeth of the cam from the teeth of the locking bar, thus allowing the locking bar to be removed from the cavity.

7. An apparatus as described in claim 6 wherein the first portion can be rotated around the central axis of the locking bar before mating with the second portion.

8. An apparatus as described in claim 5 wherein the latching mechanism is lockable.

9. An apparatus as described in claim 4 wherein the removable joint between the two portions being securable by:
the first portion being further comprised of a compressible notch;
the second portion being further comprised of a locking lever extending into the compressible notch of the first portion; and
a fastener passing through the notch and the locking lever;
the fastener exerting a friction force on the locking lever by compressing the compressible notch.

10. An apparatus as described in claim 9 wherein the fastener is lockable.

11. An apparatus as described in claim 1 wherein the first curved end is lined on the inside of the curve with padding.

12. An apparatus as described in claim 1 wherein the second curved end is lined on the inside of the curve with padding.

13. An apparatus as described in claim 1 wherein the first curved end is shaped to mate with a bicycle wheel frame.

14. An apparatus as described in claim 1 wherein the body and the curved ends are comprised of a metal structural frame.

15. An apparatus as described in claim 14 wherein the metal structural frame is encased in a non-abrasive material.

16. An apparatus as described in claim 15 wherein the non-abrasive material is a rubberized coating.

17. An apparatus as described in claim 15 wherein the non-abrasive material is a plastic.

18. An apparatus as described in claim 4 wherein the two portions of the body are secured by:
at least one guide bar;
the bar being permanently secured to the second portion and extending therefrom:
the bar being removably insertable into a cavity in the first portion; and
the first portion being jointed to the second portion by an expandable component biasing the two portions together, and being expandable to separate the two portions by allowing the guild bar to partially remove from the cavity in the first portion.

19. An apparatus as described in claim 18 wherein the expandable component is an elastic cord.

20. A method of securing a bicycle wheel comprising:
utilizing an apparatus comprised of:
an elongated body, the body being joinable separatable into two halves;
each half haying a curved portion at the distal ends;
securing the curved portions of the apparatus to the wheel and/or the frame of the bicycle to prevent the free rotation of the wheel.
